(19) United States
(12) Patent Application Publication
(10) Pub. No.: US 2019/0170071 A1
(43) Pub. Date: Jun. 6, 2019

(54) CONTROLLER OF INTERNAL COMBUSTION ENGINE

(71) Applicant: HONDA MOTOR CO., LTD., Tokyo (JP)

(72) Inventors: Mitsuo Hashizume, Wako-shi (JP); Yujiro Tsutsumi, Wako-shi (JP); Hiroyasu Motoi, Wako-shi (JP); Chiho Chinda, Wako-shi (JP); Hiroaki Tone, Wako-shi (JP); Hideyuki Yasuda, Wako-shi (JP)

(73) Assignee: HONDA MOTOR CO., LTD., Tokyo (JP)

(21) Appl. No.: 16/210,296

(22) Filed: Dec. 5, 2018

(30) Foreign Application Priority Data
Dec. 5, 2017 (JP) 2017-233451

(51) Int. Cl. F02D 35/02; F02D 41/00; F02B 37/18; F02D 37/02

(52) U.S. Cl. CPC F02D 35/028; F02D 41/0007; F02B 37/18; F02D 2041/001; F02D 35/025; F02D 2200/0414; F02D 37/02

(57) ABSTRACT

A controller of an internal combustion engine retards the ignition timing by a soot suppression necessary retard amount IGCR as a retard amount for suppressing the soot generation amount in exhaust gas, from an optimal ignition timing IGMBT, according to a detected operation state, e.g., engine water temperature TW, charging efficiency ETAC, engine speed NE, of an internal combustion engine 3. A controller of an internal combustion engine of a second invention retards an ignition timing IGLOG to suppress the soot generation amount in exhaust gas, according to an operation state of the internal combustion engine 3, in a normally aspirated operation state where the charging efficiency ETAC is not higher than 100%, and in a turbocharged operation state.

### CROSS-REFERENCE OF RELATED APPLICATION

This application claims priority of Japanese Patent Application No. 2017-233451 filed in Japan on Dec. 5, 2017, the entire contents of which are incorporated herein by reference.

### TECHNICAL FIELD

The present invention relates to a controller of an internal combustion engine, and particularly to a controller that controls the ignition timing, to reduce the generation amount of particulate matter such as soot in exhaust gas of an internal combustion engine.

### BACKGROUND OF THE INVENTION

As a conventional controller of an internal combustion engine, a controller disclosed in International Patent Application Publication No. WO 2015/063874, for example, has been known. The controller is aimed to achieve both suppression of particulate matter in exhaust gas, and increase in exhaust gas temperature for catalyst heating at the time of a cold start. The controller includes a particulate matter sensor that detects particulate matter concentration in exhaust gas, and an exhaust gas temperature sensor that detects the temperature of exhaust gas.

In this controller, engine fuel injection control and ignition control are performed on the basis of the particulate matter concentration and exhaust gas temperature detected by the sensors. For example, when the exhaust gas temperature is lower than a predetermined temperature and particulate matter concentration is lower than a predetermined concentration, the ignition timing and fuel injection timing are retarded. Instead, when the exhaust gas temperature is lower than the predetermined temperature and particulate matter concentration is not lower than the predetermined concentration, the controller performs control to retard the ignition timing and increase the ignition energy.

However, in the conventional controller described above, suppression of particulate matter requires use of the particulate matter sensor and exhaust gas temperature sensor. This complicates the configuration and control processing of the controller, and leads to an increase in cost. Additionally, since the ignition timing is controlled on the basis of the detection result of particulate matter concentration in exhaust gas, some particulate matter is inevitably emitted during the ignition timing control. Hence, particulate matter cannot be suppressed favorably.

There is a need to solve the above problems and to provide a controller of an internal combustion engine that can favorably suppress the generation amount of particulate matter in exhaust gas, by performing retard control of the ignition timing according to the operation state of the internal combustion engine.

### SUMMARY OF THE INVENTION

According to a first embodiment of the present invention, a controller of an internal combustion engine includes: operation state detection means that detects an operation state of an internal combustion engine 3; retard amount calculation means (ECU 2, step 2 of FIG. 3, FIG. 4 in the embodiment (the same applies hereinafter in this section)) that calculates, according to the detected operation state of the internal combustion engine 3, a particulate matter suppression retard amount (soot suppression retard amount IGCR) as a retard amount for suppressing a generation amount of particulate matter in exhaust gas of the internal combustion engine; and retard control means (ECU 2, steps 2, 7, 11 of FIG. 3, FIG. 4) that performs particulate matter suppression retard control, in which an ignition timing is retarded by the particulate matter suppression retard amount from a predetermined reference ignition timing.

According to the first embodiment according to the present invention, a particulate matter suppression retard amount as a retard amount for suppressing a generation amount of particulate matter in exhaust gas of the internal combustion engine is calculated according to the detected operation state of the internal combustion engine, and particulate matter suppression retard control, in which an ignition timing is retarded by the particulate matter suppression retard amount from a predetermined reference ignition timing is performed. Accordingly, since the ignition timing is retarded by the particulate matter suppression necessary retard amount and the combustion temperature is reduced, the generation amount of particulate matter such as soot in exhaust gas can be suppressed. Also, since the particulate matter suppression retard amount is calculated beforehand according to the detected operation state of the internal combustion engine, and is used for particulate matter suppression retard control, unlike conventional controllers, there is no need to detect particulate matter concentration in exhaust gas actually discharged from the internal combustion engine. This can accordingly suppress emission of particulate matter.

According to a second embodiment of the present invention, the controller of an internal combustion engine described in the first embodiment further includes reference ignition timing calculation means (ECU 2, step 1 of FIG. 3) that calculates, according to the operation state (engine speed NE, suction pressure PBA) of the internal combustion engine 3, an optimal ignition timing IGMBT when a maximum output torque of the internal combustion engine 3 is obtained, as the reference ignition timing. The retard control means sets an ignition timing IGLOG (steps 7, 11 of FIG. 3) by retarding the ignition timing by the particulate matter suppression retard amount from the optimal ignition timing IGMBT.

According to this configuration, an optimal ignition timing when the maximum output torque of the internal combustion engine is obtained is calculated as a reference ignition timing, according to the operation state of the internal combustion engine, and an ignition timing is set by retarding the ignition timing by the particulate matter suppression retard amount from the optimal ignition timing. Since the optimal ignition timing is thus used as a reference to retard the ignition timing by the particulate matter suppression retard amount, the particulate matter generation amount can be suppressed while favorably maintaining the traveling performance and fuel economy.

According to a third embodiment of the present invention, the controller of an internal combustion engine described in any one of the first and second embodiments is further characterized in that: the operation state detection means detects a temperature (engine water temperature TW) of the internal combustion engine as an operation state of the internal combustion engine 3; and the retard control means performs the particulate matter suppression retard control when the detected temperature of the internal combustion engine is within a predetermined low-temperature region.

When the temperature of the internal combustion engine is low, a locally rich (uneven distribution of unburned fuel) area is likely to occur due to attachment of fuel to a wall surface inside the cylinder. Hence, reduction in the combustion temperature caused by a retarded ignition timing can achieve a distinct effect of suppressing the particulate matter generation amount. On the other hand, when the temperature of the internal combustion engine is high, the inside of the cylinder is warmed sufficiently, and therefore occurrence of locally rich areas is suppressed. Hence, the retarded ignition timing achieves only a small effect of suppressing the particulate matter generation amount. From this view point, according to the present invention, the particulate matter suppression retard control is performed on condition that the detected temperature of the internal combustion engine is within a predetermined low-temperature region. With this, the particulate matter suppression effect can be achieved effectively in the low-temperature region, and retardation of the ignition timing in the high-temperature region where the suppression effect is small can be avoided to avoid deterioration in traveling performance and fuel economy.

According to a fourth embodiment of the present invention, the controller of an internal combustion engine described in any one of the first to third embodiments is further characterized in that: the internal combustion engine 3 is mounted on a vehicle as a power source; and the retard control means performs (steps 21, 23, 25 of FIG. 4) the particulate matter suppression retard control, in a load operation state of the internal combustion engine 3 other than an idle operation state, and a no-load operation state where the vehicle is parked and a shift lever of the vehicle is in neutral or parking.

Normally, in an idle operation state, speed control is performed to maintain the speed of the internal combustion engine at a target idle speed, whereas in a no-load operation state, speed control is performed to prevent increase (racing) in the speed by depression of an accelerator pedal. Considering this point, according to the present invention, prohibition of particulate matter suppression retard control during the idle operation state and the no-load operation state enables preferential and stable speed control. In load operation states of the internal combustion engine other than the above states, particulate matter suppression retard control is performed to achieve the effect of suppressing the particulate matter generation amount as much as possible.

According to a fifth embodiment of the present invention, the controller of an internal combustion engine described in any one of the second to fourth embodiments is further characterized in that: the operation state detection means detects a speed (engine speed NE), a load (charging efficiency ETAC), and a temperature (engine water temperature) of the internal combustion engine 3 as an operation state of the internal combustion engine 3; and the retard amount calculation means calculates (step 29 of FIG. 4, FIG. 5) the particulate matter suppression retard amount on the basis of the detected speed, load, and temperature of the internal combustion engine 3.

It has been confirmed that the speed, load, and temperature of the internal combustion engine are closely connected with the generation amount of particulate matter in exhaust gas. Based on this knowledge, according to the present invention, the speed, load, and temperature of the internal combustion engine are used as parameters indicating the operation state of the internal combustion engine, and a particulate matter suppression retard amount is calculated on the basis of detection results thereof. Hence, an excellent effect of suppressing the particulate matter can be achieved.

In addition, the three operation parameters of the internal combustion engine are generally used to control the internal combustion engine, and therefore normally provided existing sensors can be used for detection thereof. Hence, special devices such as a particulate matter sensor and an exhaust gas temperature sensor in conventional controllers are unnecessary, and the configuration, control processing, and the like of the controller can be simplified. Furthermore, since the above operation state parameters are used, unlike conventional controllers, there is no need to detect particulate matter concentration in exhaust gas discharged from the internal combustion engine. This can further suppress emission of particulate matter.

According to a sixth embodiment of the present invention, the controller of an internal combustion engine described in any one of the second to fifth embodiments is further characterized in that the retard amount calculation means calculates (FIG. 9, FIG. 10), at the start of the particulate matter suppression retard control, the particulate matter suppression retard amount, so that the particulate matter suppression retard amount gradually varies from a value immediately before the start, toward the retard side.

According to this configuration, at the start of particulate matter suppression retard control, the particulate matter suppression retard amount gradually varies from a value immediately before the start of the particulate matter suppression retard control, toward the retard side. Hence, an abrupt change in the particulate matter suppression retard amount at the start of particulate matter suppression retard control can be prevented, and elevation changes in the output torque of the internal combustion engine and excessive deceleration can be prevented.

According to a seventh embodiment of the present invention, the controller of an internal combustion engine described in any one of the second to sixth embodiments is further characterized in that the retard amount calculation means calculates (FIG. 11, FIG. 12), at the end of the particulate matter suppression retard control, the particulate matter suppression retard amount, so that the particulate matter suppression retard amount gradually varies from a value immediately before the end, toward the advance side.

According to this configuration, at the end of particulate matter suppression retard control, the particulate matter suppression retard amount gradually varies from a value immediately before the end of the particulate matter suppression retard control, toward the advance side. Hence, an abrupt change in the particulate matter suppression retard amount at the end of particulate matter suppression retard control can be prevented, and elevation changes in the output torque of the internal combustion engine and excessive acceleration can be prevented.

According to an eighth embodiment of the present invention, the controller of an internal combustion engine described in any one of the second to seventh embodiments is further characterized in that: the operation state detection means detects an atmospheric pressure PA as an operation state of the internal combustion engine 3; and the retard amount calculation means calculates (step 30 of FIG. 4, FIG. 7) the particulate matter suppression retard amount, so that the particulate matter suppression retard amount is limited more strictly for a lower value of the detected atmospheric pressure PA.

A lower atmospheric pressure, that is, higher altitude of the internal combustion engine, causes lower density of air, whereby the output torque of the internal combustion engine is reduced even more. According to this configuration, the particulate matter suppression retard amount is limited more strictly for a lower detected atmospheric pressure, to suppress reduction of output torque by a retarded ignition timing. With this, when the internal combustion engine is mounted on a vehicle, for example, an output torque required for starting the vehicle at high altitude can be ensured, and excellent startability of the vehicle can be ensured.

According to a ninth embodiment of the present invention, the controller of an internal combustion engine described in any one of the second to eighth embodiments is further characterized in that: the operation state detection means detects a temperature (engine water temperature TW) of the internal combustion engine as an operation state of the internal combustion engine 3; and the retard amount calculation means calculates (step 30 of FIG. 4, FIG. 7) the particulate matter suppression retard amount, so that the particulate matter suppression retard amount is limited more strictly for a lower value of the detected temperature of the internal combustion engine.

A low temperature of the internal combustion engine causes low combustion efficiency and large friction, whereby the output torque of the internal combustion engine is reduced even more. According to this configuration, the particulate matter suppression retard amount is limited more strictly for a lower detected temperature of the internal combustion engine, to suppress reduction of output torque by a retarded ignition timing. With this, when the internal combustion engine is mounted on a vehicle, for example, an output torque required for starting the vehicle at the time of a cold start can be ensured, and excellent startability of the vehicle can be ensured.

According to a tenth embodiment of the present invention, the controller of an internal combustion engine described in any one of the first to ninth embodiments is characterized by further including: target intake amount setting means (ECU 2, step 71 of FIG. 14) that sets a target intake amount (basic value GAIRBS of target intake amount) according to a target torque TRQCMD of the internal combustion engine; intake amount correction parameter calculation means (ECU 2, step 72 of FIG. 14) that calculates, according to the particulate matter suppression retard amount, an intake amount correction parameter (torque-down rate KTRQDN) for compensating for an intake amount corresponding to a reduced amount of output torque of the internal combustion engine 3 when the particulate matter suppression retard control has been performed; and intake amount correction means (ECU 2, step 73 of FIG. 14) that increases and corrects the set target intake amount by use of the calculated intake amount correction parameter.

According to this configuration, the target intake amount is set according to a target torque of the internal combustion engine, and an intake amount correction parameter is calculated according to the particulate matter suppression retard amount. The intake amount correction parameter is provided to compensate for an intake amount corresponding to a reduced amount of output torque of the internal combustion engine when particulate matter suppression retard control has been performed.

Then, the set target intake amount is increased and corrected by use of the calculated intake amount correction parameter. With this, the intake amount corresponding to the reduced amount of output torque when particulate matter suppression retard control has been performed is appropriately compensated for. Hence, reduction of the output torque of the internal combustion engine can be prevented, and the target torque can be ensured.

According to an eleventh embodiment of the present invention, the controller of an internal combustion engine described in any one of the second to tenth embodiments is characterized by further including: knocking suppression retard amount calculation means (ECU 2, step 3 of FIG. 3) that calculates a knocking suppression retard amount (knocking suppression necessary retard amount IGKNOCK) as an ignition timing retard amount for suppressing knocking of the internal combustion engine 3, on the basis of an occurrence limit of the knocking; learning means (ECU 2, step 6 of FIG. 3) that updates, on the basis of the knocking suppression retard amount, a knock learning value IGKCS used for knocking control; and learning prohibition means (ECU 2, step 8 of FIG. 3) that prohibits update of the knock learning value IGKCS when the particulate matter suppression retard amount is on the retard side of the knocking suppression retard amount.

According to this configuration, a knocking suppression retard amount for suppressing knocking is calculated on the basis of an occurrence limit of knocking, and a knock learning value used for knocking control is updated on the basis of the knocking suppression retard amount. In this case, when the particulate matter suppression retard amount is on the retard side of the knocking suppression retard amount, knocking is less likely to occur. Hence, if knocking is learned on the basis of the retard amount at this point, an erroneous learning result that does not reflect the actual occurrence limit of knocking is obtained. From this viewpoint, according to the present invention, update of the knock learning value is prohibited when the particulate matter suppression retard amount is on the retard side of the knocking suppression retard amount. Hence, erroneous learning of knocking can be surely avoided.

According to a twelfth embodiment of the present invention, the controller of an internal combustion engine described in any one of the second to eleventh embodiments is further characterized in that: the internal combustion engine 3 has a turbocharger (turbocharger 9) that turbocharges intake air; and during a turbocharged operation by the turbocharger, the retard amount calculation means calculates the particulate matter suppression retard amount, so that the particulate matter suppression retard amount is limited more strictly for a higher load (charging efficiency ETAC) of the internal combustion engine, and sets the particulate matter suppression retard amount to 0 (step 38 of FIG. 4, Equation (2), FIG. 8) when a turbocharge pressure is a maximum turbocharge pressure.

The present invention relates to calculation of a particulate matter suppression retard amount during a turbocharged operation, when the internal combustion engine has a turbocharger. According to this configuration, during turbocharged operation, the particulate matter suppression retard amount is limited more strictly for a higher load of the internal combustion engine. Hence, reduction of output torque by a retarded ignition timing is suppressed even more. Additionally, when the turbocharge pressure is the maximum turbocharge pressure, the particulate matter suppression retard amount is set to 0. Hence, reduction of output torque by a retarded ignition timing is eliminated. As has been described, an appropriate effect of suppressing the particulate matter can be achieved while also ensuring an output torque corresponding to the load on the internal combustion engine, during the turbocharged operation state.

To achieve the aforementioned objective, according to a thirteenth embodiment of the present invention, a controller of an internal combustion engine has a turbocharger (turbocharger 9) that turbocharges intake air, the controller including: operation state detection means that detects an operation state of the internal combustion engine 3; and ignition timing retard control means (ECU 2, steps 2, 7, 11 of FIG. 3, step 38 of FIG. 4, FIG. 8) that performs particulate matter suppression retard control in which an ignition timing IGLOG is retarded to suppress a generation amount of particulate matter in exhaust gas of the internal combustion engine 3, according to the detected operation state of the internal combustion engine 3, in a normally aspirated operation state where operation of the turbocharger is stopped, and in a turbocharged operation state.

According to the embodiment of the present invention, when an internal combustion engine has a turbocharger, particulate matter suppression retard control is performed according to the detected operation state of the internal combustion engine in a normally aspirated operation state where operation of the turbocharger is stopped, and in a turbocharged operation state, and a resultant retarded ignition timing suppresses the generation amount of particulate matter in exhaust gas. With this, the effect of suppressing particulate matter can be achieved favorably not only in the normally aspirated operation state, but also in the turbocharged operation state.

### BRIEF DESCRIPTION OF THE DRAWINGS

FIG. 1 is a schematic diagram of an internal combustion engine to which the present invention is applied.

FIG. 2 is a block diagram of a controller.

FIG. 3 is a flowchart of ignition timing control processing.

FIG. 4 is a flowchart of soot suppression request retard amount calculation processing.

FIG. 5 is a basic value map of soot suppression request retard amount used in the processing of FIG. 4.

FIG. 6 is a diagram illustrating how basic values of the basic value map of FIG. 5 are set.

FIG. 7 is a limit value map used in the processing of FIG. 4.

FIG. 8 is a diagram illustrating a soot suppression request amount calculated in a turbocharge region.

FIG. 9 is a flowchart of control start transition processing.

FIG. 10 is a timing chart of an example of soot suppression request retard amount calculation by the processing of FIG. 9.

FIG. 11 is a flowchart of control end transition processing.

FIG. 12 is a timing chart of an example of soot suppression request retard amount calculation by the processing of FIG. 11.

FIG. 13 is a timing chart of an operation example based on the processing of FIG. 4 and other processings.

FIG. 14 is a flowchart of intake amount correction processing according to the soot suppression request retard amount.

### DETAILED DESCRIPTION OF EMBODIMENTS OF THE INVENTION

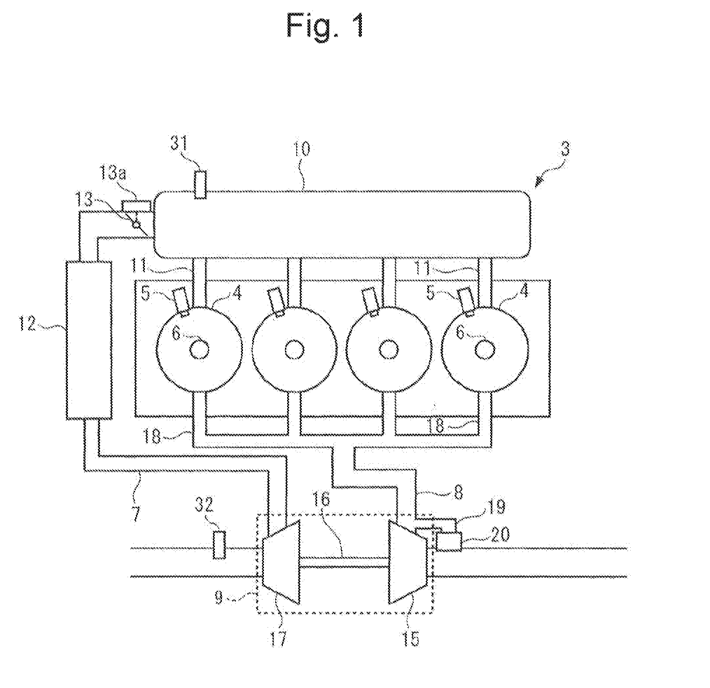

Hereinafter, preferred embodiments of the present invention will be described with reference to the drawings. An internal combustion engine (Hereinafter, referred to as “engine”) 3 illustrated in FIG. 1 has four cylinders 4, is a direct-injection gasoline engine in which fuel is directly injected into a combustion chamber (not shown), and is mounted on a vehicle (not shown).

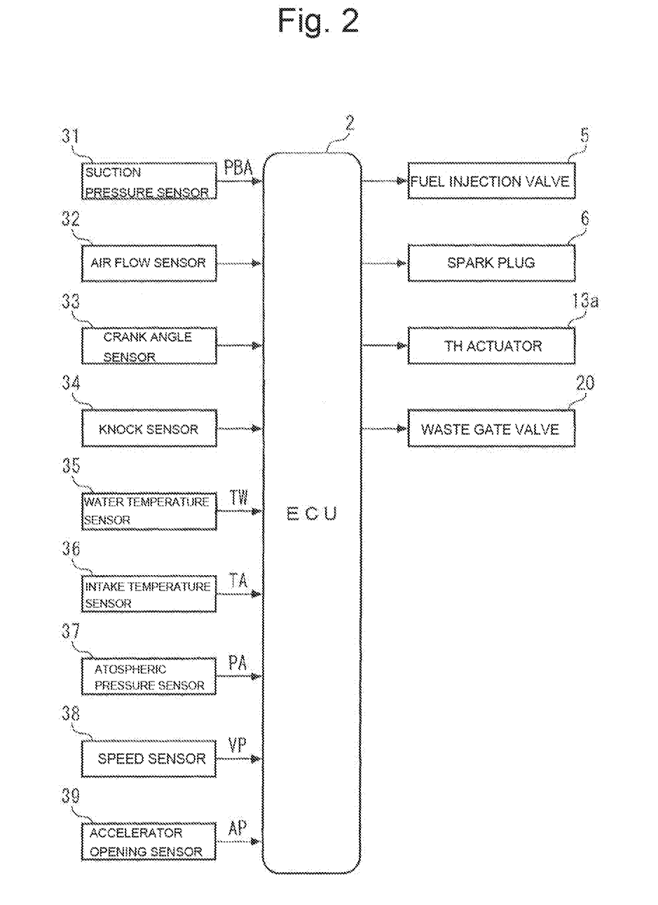

A fuel injection valve 5 and a spark plug 6 are provided in each cylinder 4. An ECU (electronic control unit) 2 (see FIG. 2) controls the open time of the fuel injection valve 5, and thereby controls a fuel injection amount GFUEL. The ECU 2 also controls an ignition timing IGLOG of the spark plug 6.

The engine 3 includes an intake valve, an exhaust valve, and a piston (none of the parts are shown) for each cylinder 4, and also includes an intake passage 7, an exhaust passage 8, and a turbo charger 9. The intake passage 7 is connected to a surge tank 10, and the surge tank 10 is connected to the combustion chamber of each of the cylinders 4 through an intake manifold 11. An intercooler 12 for cooling air compressed by the turbo charger 9, and a throttle valve 13 arranged on the downstream side thereof are provided in the intake passage 7.

A TH actuator 13a is connected to the throttle valve 13. The ECU 2 controls operation of the TH actuator 13a to control the opening of the throttle valve 13, and thereby adjusts an intake amount (fresh air amount) GAIR sucked into the combustion chamber. A suction pressure sensor 31 for detecting a suction pressure PBA is provided in the surge tank 10, and an airflow sensor 32 for detecting an intake airflow amount is provided in the intake passage 7.

The exhaust passage 8 is connected to the combustion chamber of each of the cylinders 4 of the engine 3 through an exhaust manifold 18. The turbo charger 9 is arranged in the exhaust passage 8, and has a turbine 15 rotated by the operation energy of exhaust gas, and a compressor 17 connected integrally with the turbine 15 through a shaft 16. The compressor 17 is arranged in the intake passage 7, and is configured to compress (pressurize) air flowing through the intake passage 7 to turbocharge intake air.

Additionally, a bypass passage 19 that bypasses the turbine 15 is connected to the exhaust passage 8, and an electrically-driven waste gate valve 20 that controls the flow rate of exhaust gas passing through the bypass passage 19 is provided in the bypass passage 19. The ECU 2 controls operation of the waste gate valve 20 (see FIG. 2).

The ECU 2 is connected not only to the aforementioned suction pressure sensor 31 and airflow sensor 32, but also to a crank angle sensor 33, a knock sensor 34 that detects whether knocking has occurred in the engine 3, a water temperature sensor 35 that detects a cooling water temperature (Hereinafter, referred to as “engine water temperature”) TW of the engine 3, an intake temperature sensor 36 that detects an intake temperature TA, an atmospheric pressure sensor 37 that detects an atmospheric pressure PA, a vehicle speed sensor 38 that detects a vehicle speed (speed of vehicle) VP, and an accelerator opening sensor 39 that detects a depression amount (Hereinafter, referred to as “accelerator opening”) AP of an accelerator pedal (not shown) of the vehicle. Detection signals of these parts are input into the ECU 2.

The crank angle sensor 33 described above outputs a CRK signal and a TDC signal, which are pulse signals, along with rotation of a crankshaft. The CRK signal is output at every predetermined crank angle (e.g., 30°). The ECU 2 calculates an engine speed NE on the basis of the CRK signal. The TDC signal is a signal indicating that a piston is near an intake TDC in any one of the cylinders 4, and when the engine 3 is a four-cylinder engine, the TDC signal is output at every 180-degree crank angle.

The ECU 2 is configured of a microcomputer formed of an input/output interface, a CPU, a RAM, a ROM, and other parts. The ECU 2 determines an operation state of the engine 3 according to detection signals of the aforementioned sensors 31 to 39, and also controls fuel injection by the fuel injection valve 5, controls the ignition timing by the sparkplug 6, and controls turbocharging by the waste gate valve 20, for example.

In the embodiment, the ECU 2 corresponds to retard control means, reference ignition timing calculation means, retard amount calculation means, target intake amount setting means, intake amount correction means, nocking suppression retard amount calculation means, learning means, learning prohibition means, and ignition timing retard control means.

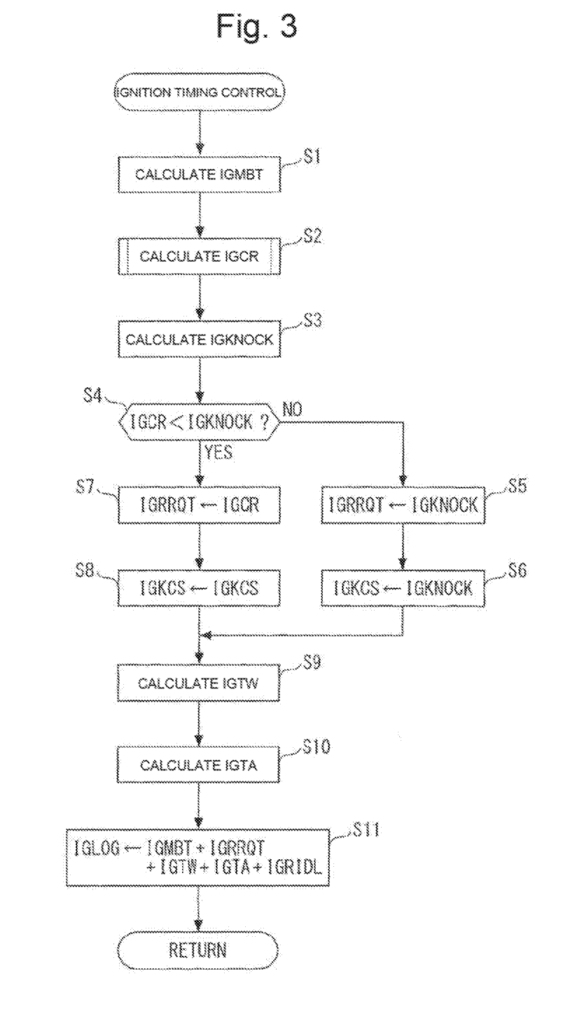

FIG. 3 shows ignition timing control processing performed by the ECU 2. In this ignition timing control processing, the ignition timing IGLOG is controlled, while soot suppression retard control for suppressing the generation amount of soot (particulate matter) in exhaust gas of the engine 3 is performed according to need. Ignition timing control processing is repeated in synchronization with generation of a TDC signal. Note that in the embodiment, the ignition timing IGLOG is defined as an advance amount from the compression top dead center. Specifically, the compression top dead center is used as a reference (0 degrees), the advance side is calculated as a positive value, and later-mentioned retard amounts of the ignition timing are calculated as negative values.

In the processing, first, in step 1 (indicated as “S1” in FIG. 3, the same applies hereinafter), an optimal ignition timing IGMBT is calculated. The optimal ignition timing IGMBT is an ignition timing when the maximum output torque of the engine 3 is obtained, and is calculated by searching a predetermined map (not shown) according to the engine speed NE and the suction pressure PBA.

Next, a soot suppression necessary retard amount IGCR is calculated (step 2). The soot suppression necessary retard amount IGCR is a retard amount necessary for suppressing the soot generation amount in exhaust gas. Calculation processing of the soot suppression necessary retard amount IGCR will be described later.

Next, a knocking suppression necessary retard amount IGKNOCK is calculated (step 3). The knocking suppression necessary retard amount IGKNOCK is a retard amount necessary for suppressing knocking, and is calculated by a publicly known method. Specifically, the knocking suppression necessary retard amount IGKNOCK is varied to the retard side by a predetermined amount every time knocking is detected, on the basis of the occurrence state (occurrence limit) of knocking detected by the knock sensor 34. During a period when knocking is not detected, the knocking suppression necessary retard amount is gradually varied to the advance side.

Next, it is determined whether the soot suppression necessary retard amount IGCR is smaller than the knocking suppression necessary retard amount IGKNOCK, that is, closer to the retard side (step 4). If the answer is NO, a necessary retard amount IGRRQT is set as the knocking suppression necessary retard amount IGKNOCK (step 5). In addition, the knocking suppression necessary retard amount IGKNOCK is set as a knock learning value IGKCS to update the knock learning value IGKCS (step 6).

Meanwhile, if the answer in step 4 is YES, the necessary retard amount IGRRQT is set as the soot suppression necessary retard amount IGCR (step 7). As is clear from the above steps 5 and 7, the necessary retard amount IGRRQT is set to either the soot suppression necessary retard amount IGCR or the knocking suppression necessary retard amount IGKNOCK that is closer to the retard side. Next, the last knock learning value IGKCS is maintained (step 8). In other words, when the soot suppression necessary retard amount IGCR is on the retard side of the knocking suppression necessary retard amount IGKNOCK, update of the knock learning value IGKCS is prohibited.

In step 9 following the step 6 or 8, a water temperature correction amount IGTW is calculated according to the engine water temperature TW. In the next step 10, an intake temperature correction amount IGTA is calculated according to the intake temperature TA.

Lastly, in step 11, the ignition timing IGLOG is calculated by assigning the optimal ignition timing IGMBT, the necessary retard amount IGRRQT, The water temperature correction amount IGTW, and the intake temperature correction amount IGTA to the following Equation (1).

IGLOG=IGMBT+IGRRQT+IGTW+IGTA+IGRIDL (1)

In Equation (1), IGRIDL on the right side is a predetermined idle retard amount applied to maintain the engine speed at a target speed, for example, during idle operation and start control performed thereafter. During a transition period from the start control to normal operation, the idle retard amount is set to gradually converge to value 0.

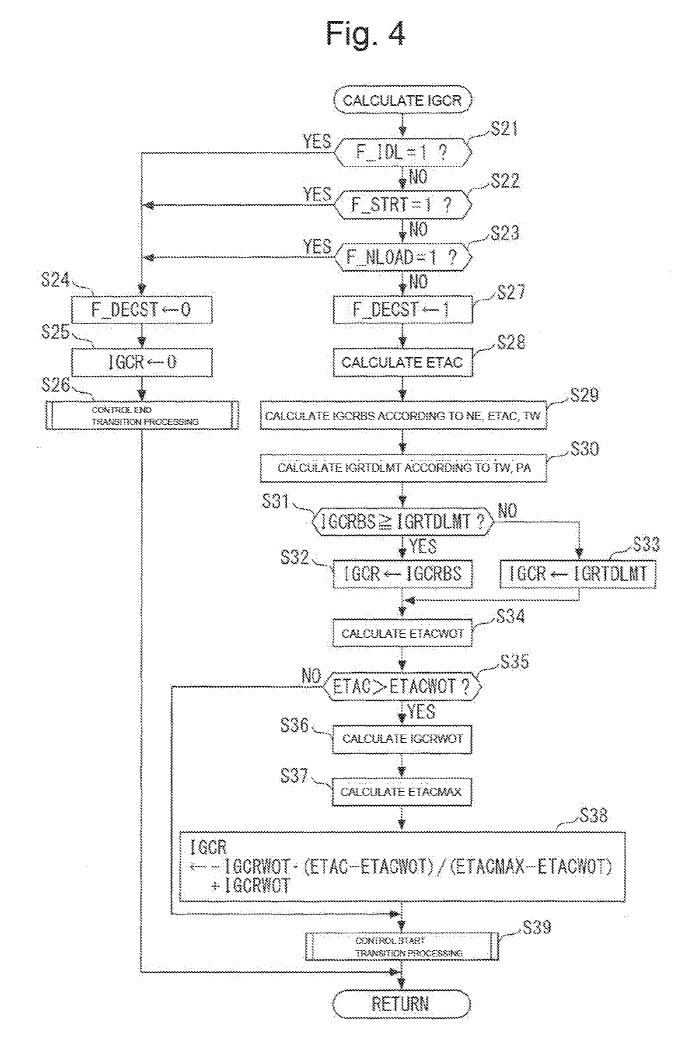

FIG. 4 shows a subroutine of calculation processing of the soot suppression necessary retard amount IGCR performed in step 2 of FIG. 3. In the processing, first, in steps 21 to 23, it is determined whether each of an idle flag F_IDL, a start control flag F_STRT, and a no-load control flag F_NLOAD is set to “1”. Here, no-load control is speed control according to the intake air amount, for example, performed to prevent increase (racing) in the engine speed NE by depression of the accelerator pedal, in a no-load operation state where a shift lever is in parking or neutral while the vehicle is stopped.

If the answer in any of the steps 21 to 23 is YES and idle operation, start control, or no-load control is performed, speed control according to the ignition timing or intake air amount is performed to maintain the engine speed NE at a target speed. Since the speed control is given a higher priority, it is determined that the condition for performing soot suppression retard control is not satisfied, and a soot suppression retard control flag F_DECST is set to “0” (step 24), while the soot suppression necessary retard amount IGCR is set to value 0 (step 25).

Next, in step 26, control end transition processing is performed to end the processing in FIG. 4. The control end transition processing is performed in a transition period immediately after the end of soot suppression retard control, to gradually increase the soot suppression necessary retard amount IGCR from the value immediately before the end of the soot suppression retard control, to value 0. Details will be described later.

If the answers in all of the steps 21 to 23 are NO, it is determined that the condition for performing soot suppression retard control is satisfied, and the soot suppression retard control flag F_DECST is set to “1” (step 27), while in and after step 28, the soot suppression necessary retard amount IGCR is calculated according to the operation state of the engine 3.

First, in step 28, a charging efficiency ETAC is calculated. The calculation is done by searching a predetermined map (not shown) according to the suction pressure PBA and the intake amount GAIR, for example.

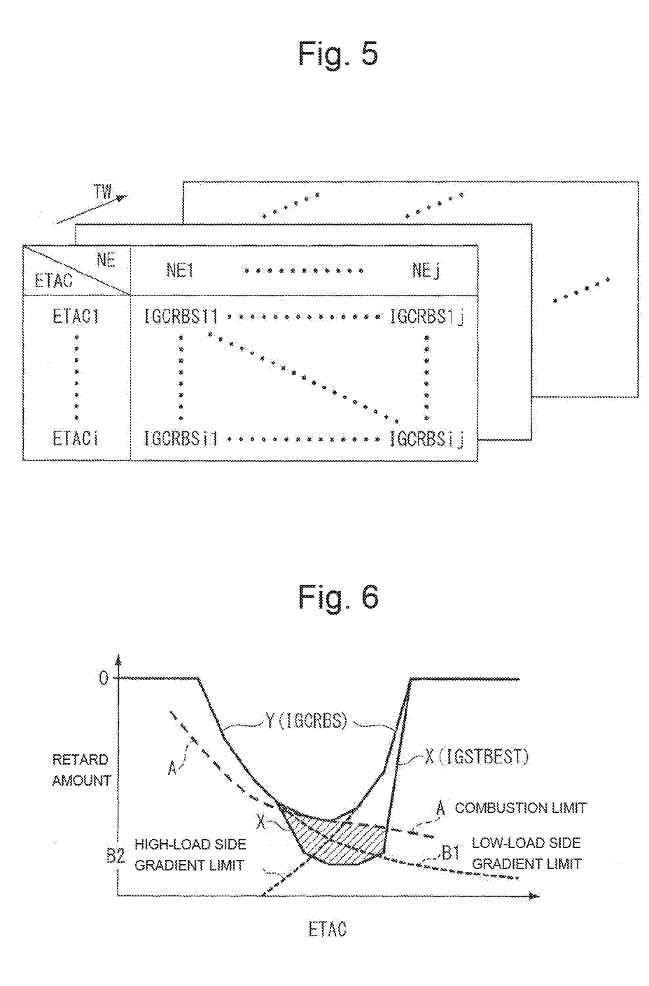

Next, a basic value IGCRBS of the soot suppression necessary retard amount IGCR is calculated (step 29), by searching a basic value map shown in FIG. 5 according to the engine speed NE, the charging efficiency ETAC, and the engine water temperature TW. Regarding the engine water temperature TW, the basic value map is set for a low-water temperature region lower than a predetermined temperature. In a high-water temperature region where the engine water temperature TW is not lower than the predetermined temperature, the basic value IGCRBS is set to value 0.

This is because in the low-water temperature region, a locally rich (uneven distribution of unburned fuel) area is likely to occur due to attachment of fuel to a wall surface inside the cylinder 4. Hence, reduction in the combustion temperature caused by a retarded ignition timing can achieve a distinct effect of suppressing the soot generation amount. On the other hand, in the high-water temperature region, the inside of the cylinder 4 is warmed sufficiently, and therefore occurrence of locally rich areas is suppressed. Hence, the retarded ignition timing achieves only a small effect of suppressing the soot generation amount. For the same reason, in the low-water temperature region, the basic value IGCRBS is set closer to the retard side (larger absolute value) for a lower engine water temperature TW. With this setting, the basic value IGCRBS can be set appropriately relative to the temperature of the engine 3, and unnecessary retardation of the ignition timing can be avoided in the high-water temperature region where the effect of suppressing the soot generation amount is small.

Moreover, in addition to the viewpoint of suppressing the soot generation amount, the basic value map is created on the basis of a viewpoint of ensuring combustion stability in the low-water temperature region, stability in controlling devices such as the throttle valve 13, and continuity of the output torque of the engine 3. For example, FIG. 6 shows an example of setting the basic value IGCRBS when the engine water temperature TW is a controlled condition within the low-water temperature region, and the engine speed NE is a controlled condition.

In FIG. 6, a solid line X indicates a retard amount (Hereinafter, referred to as “soot suppression best retard amount”) IGSTBEST resulting from the best soot suppression effect, which is obtained on the basis of an experiment result, for example, and a solid line Y indicates the basic value IGCRBS finally set in the basic value map. Additionally, a broken line A indicates a combustion limit line, and shows the lower limit value of a retard amount that can ensure combustion stability under a given water temperature and speed condition, that is, a retard amount that can suppress the rate of variability of combustion to a value lower than a predetermined allowable rate of variability. According to this relationship, combustion becomes unstable in a region (hatched region in FIG. 6) where the soot suppression best retard amount IGSTBEST drops below (closer to the retard side) the combustion limit line. Hence, the basic value IGCRBS avoids this region and is set on the advance side of the combustion limit line A.

Moreover, dotted lines B1 and B2 in FIG. 6 respectively indicate low-load side and high-load side gradient limit lines for limiting the gradient of the retard amount relative to the charging efficiency ETAC. These gradient limit lines B1 and B2 are set for the following reason. Specifically, if the gradient of the retard amount relative to the charging efficiency ETAC is excessively large, the ignition timing needs to be varied largely for a small change in the intake amount GAIR. Such control may impair stability in the control of devices such as the throttle valve 13 and continuity of the output torque of the engine 3, and therefore needs to be avoided on the low-load side and high-load side.

For this reason, as shown in FIG. 6, when the gradient of the soot suppression best retard amount IGSTBEST is larger than the gradient of the gradient limit line B1 or B2, the basic value IGCRBS is set on the advance side of the soot suppression best retard amount IGSTBEST, so that its gradient is not larger than the gradient of the gradient limit line B1 or B2. As has been described, according to the basic value map, the basic value IGCRBS is set in such a manner as to suppress the soot generation amount as much as possible, while ensuring combustion stability in the low-water temperature region, stability of operation of devices, and continuity of the output torque.

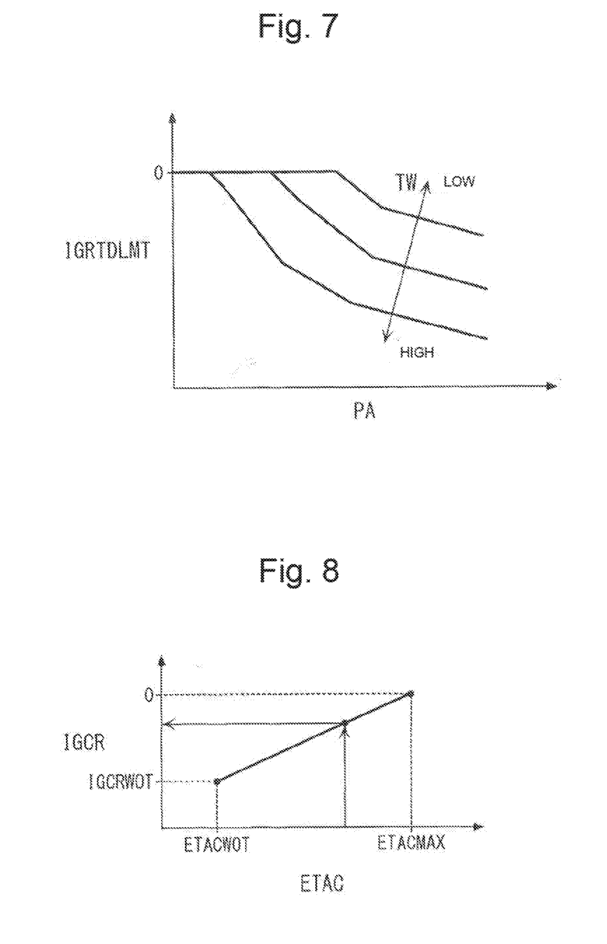

Referring back to FIG. 4, in step 30 following the step 29, a retard limit value IGRTDLMT is calculated by searching a limit value map shown in FIG. 7 according to the engine water temperature TW and the atmospheric pressure PA. The retard limit value IGRTDLMT is provided to limit the soot suppression necessary retard amount IGCR, so that the output torque of the engine 3 in a normally aspirated state and having a 100% charging efficiency ETAC (suction pressure PBA=atmospheric pressure PA) satisfies startability and salability starting of the vehicle. Hereinafter, regarding operation regions of the engine 3, a region where normal aspiration is performed is referred to as “NA region,” a normally aspirated state and having a 100% charging efficiency ETAC as mentioned above is referred to as “NA full admission,” and a region where the charging efficiency ETAC exceeds 100% is referred to as “turbocharge region.”

As shown in FIG. 7, in the limit value map, the retard limit value IGRTDLMT is set to a larger value (advance side) for a lower engine water temperature TW. This is because a low engine water temperature TW causes low combustion efficiency and large friction, whereby the output torque of the engine 3 is reduced even more. Hence, to ensure output torque, the tolerance of retardation of the ignition timing becomes even lower.

Additionally, the retard limit value IGRTDLMT is set to a larger value (advance side) for a lower atmospheric pressure PA, and is set to value 0 in a region where the atmospheric pressure PA is extremely low. This is because a low atmospheric pressure PA (when engine 3 is at high altitude) causes low density of air, whereby the output torque is reduced even more. To ensure output torque, the tolerance of retardation of the ignition torque becomes even lower, and is not allowed at all at extremely high altitude.

In step 31 following the step 30, it is determined whether the basic value IGCRBS is not smaller than the retard limit value IGRTDLMT. If the answer is YES and the basic value IGCRBS is equal to the retard limit value IGRTDLMT or on the advance side, the basic value IGCRBS is set as the soot suppression necessary retard amount IGCR (step 32). Meanwhile, if the answer in the step 31 is NO and the basic value IGCRBS is on the retard side of the retard limit value IGRTDLMT, the retard limit value IGRTDLMT is set as the soot suppression necessary retard amount IGCR to set the limit (step 33).

In and after step 34 following the step 32 or 33, the soot suppression necessary retard amount IGCR for the turbocharge region is calculated. First, in step 34, an NA full admission-charging efficiency ETACWOT is calculated. The NA full admission-charging efficiency ETACWOT corresponds to a charging efficiency obtained during NA full admission (see FIG. 8), and is calculated by assigning, to a map using the suction pressure PBA and the intake amount GAIR as input parameters and used for calculation of the charging efficiency ETAC in the step 28, the atmospheric pressure PA instead of the suction pressure PBA.

Next, it is determined whether the current charging efficiency ETAC calculated in the step 28 is larger than the NA full admission-charging efficiency ETACWOT (step 35). If the answer is NO, the engine 3 is not in the turbocharge region, and the processing proceeds to later-mentioned step 39.

Meanwhile, if the answer in step 35 is YES, the engine 3 is in the turbocharge region, and an NA full admission-retard amount IGCRWOT is calculated (step 36). As shown in FIG. 8, the NA full admission-retard amount IGCRWOT corresponds to the soot suppression necessary retard amount IGCR set for the NA full admission-charging efficiency ETACWOT. The calculation is done by calculating the basic value IGCRBS by assigning the NA full admission-charging efficiency ETACWOT instead of the charging efficiency ETAC to the map of FIG. 5, and appropriately limiting the calculated basic value IGCRBS by the retard limit value IGRTDLMT.

Next, a maximum charging efficiency ETACMAX is calculated (step 37). The maximum charging efficiency ETACMAX corresponds to a charging efficiency obtained when the suction pressure PBA (=turbocharge pressure) is a predetermined maximum turbocharge pressure POBJ, and is calculated by assigning the maximum turbocharge pressure POBJ instead of the suction pressure PBA to the map used in step 28.

Next, in step 38, the soot suppression necessary retard amount IGCR for the turbocharge region is calculated by assigning the NA full admission-charging efficiency ETACWOT, the maximum charging efficiency ETACMAX, the NA full admission-retard amount IGCRWOT, and the charging efficiency ETAC to the following Equation (2).

IGCR=−IGCRWOT·(ETAC−ETACWOT)/(ETACMAX−ETACWOT)+IGCRWOT (2)

This Equation (2) is a primary expression where the charging efficiency ETAC is a variable, and as a result of the calculation, as shown in FIG. 8, the soot suppression necessary retard amount IGCR is set to the NA full admission-retard amount IGCRWOT when the charging efficiency ETAC is the NA full admission-charging efficiency ETACWOT, and is set to value 0 when the charging efficiency ETAC is the maximum charging efficiency ETACMAX corresponding to the maximum turbocharge pressure POBJ. When the charging efficiency ETAC is between the NA full admission-charging efficiency ETACWOT and the maximum charging efficiency ETACMAX, the soot suppression necessary retard amount is calculated linearly between the NA full admission-retard amount IGCRWOT and value 0, according to the charging efficiency ETAC.

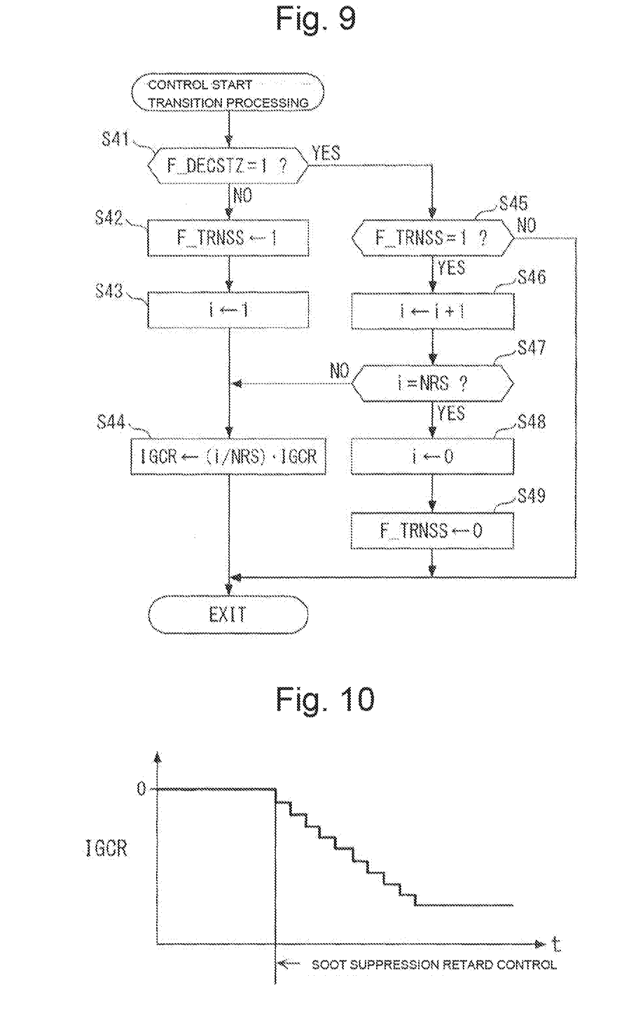

Next, in step 39, control start transition processing is performed to end the processing in FIG. 4. The control start transition processing is performed in a transition period immediately after the start of soot suppression retard control, to gradually reduce the soot suppression necessary retard amount IGCR from value 0 immediately before the start of the soot suppression retard control, to the target value of the transition destination calculated in the aforementioned manner. FIG. 9 shows the subroutine.

In the processing, first, in step 41, it is determined whether the last soot suppression retard control flag F_DECSTZ is “1.” If the answer is NO, that is, if the current processing cycle is immediately after the start of soot suppression retard control, the start transition control of the soot suppression necessary retard amount IGCR is performed. Hence, a start transition control flag F_TRNSS is set to “1” (step 42), and a counter value i indicating the number of times of the start transition control is set to 1 (step 43).

Next, the soot suppression necessary retard amount IGCR for the transition period is calculated (step 44) by the following Equation (3), to end the processing.

IGCR=(i/NRS)·IGCR (3)

Here, the IGCR on the right side indicates the soot suppression necessary retard amount IGCR calculated in step 32 and step 33 in FIG. 4, and NRS indicates a predetermined number of times.

If the answer in the step 41 is YES and the current processing cycle is not immediately after the start of soot suppression retard control, it is determined whether the start transition control flag F_TRNSS is “1” (step 45). If the answer is YES and start transition control is being performed, the counter value i is incremented (step 46), and it is determined whether the counter value i has reached the predetermined number of times NRS (step 47). If the answer is NO, the processing proceeds to the step 44, to calculate the soot suppression necessary retard amount IGCR by the Equation (3).

Meanwhile, if the answer in the step 47 is YES and the counter value i reaches the predetermined number of times NRS, the counter value i is reset to 0 (step 48), and start transition control is ended. Hence, the start transition control flag F_TRNSS is set to “0” (step 49), and the processing is ended. In addition, after performing the step 49, the answer in the step 45 turns to NO, and in this case, too, the processing is immediately ended.

With the start transition control described above, as shown in FIG. 10, the soot suppression necessary retard amount IGCR is calculated so as to gradually decrease from value 0 to the target value of the transition destination, during a predetermined transition period from the start of the soot suppression retard control.

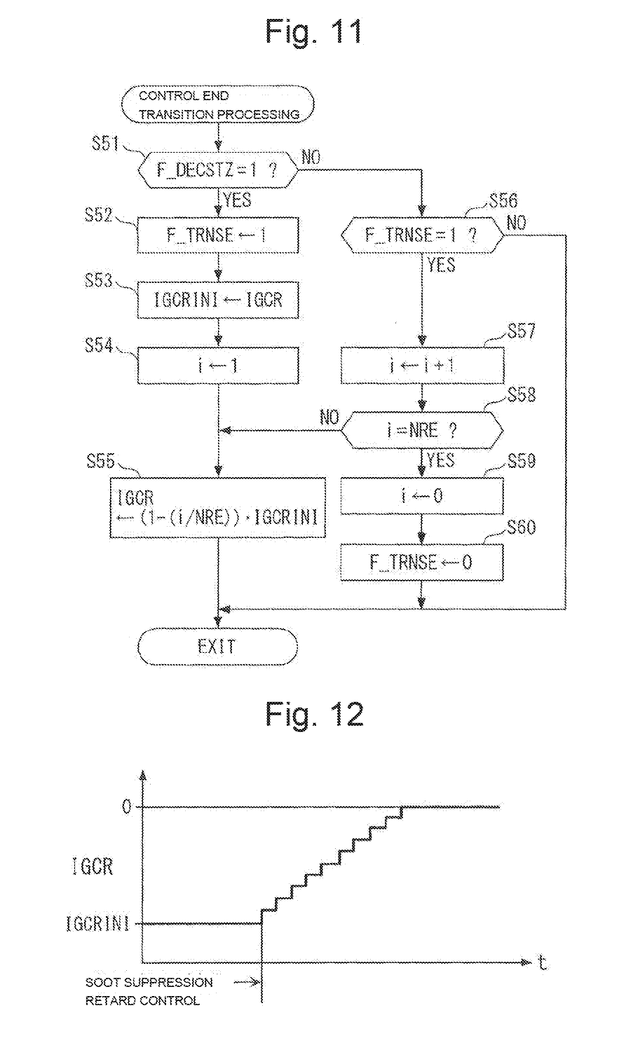

Next, control end transition processing performed in the step 26 will be described. The control end transition processing is performed inversely to the aforementioned control start transition processing, and is performed in a transition period immediately after the end of soot suppression retard control, to gradually increase the soot suppression necessary retard amount IGCR from the value immediately before the end of the soot suppression retard control, to value 0. FIG. 11 shows the subroutine.

In the processing, first, in step 51, it is determined whether the last soot suppression retard control flag F_DECSTZ is “1.” If the answer is YES, that is, if the current processing cycle is immediately after the end of soot suppression retard control, the end transition control of the soot suppression necessary retard amount IGCR is performed. Hence, an end transition control flag F_TRNSE is set to “1” (step 52), the soot suppression necessary retard amount IGCR calculated immediately before the end of soot suppression retard control is set as an initial value IGCRINI of end transition control (step 53), and the counter value i is set to 1 (step 54).

Next, the soot suppression necessary retard amount IGCR for the transition period is calculated (step 55) by the following Equation (4), to end the processing.

IGCR=(1−(i/NRE))·IGCRINI (4)

Here, NRE indicates a predetermined number of times.

If the answer in the step 51 is YES and the current processing cycle is not immediately after the end of soot suppression retard control, it is determined whether the end transition control flag F_TRNSE is “1” (step 56). If the answer is YES and end transition control is being performed, the counter value i is incremented (step 57), and it is determined whether the counter value i has reached the predetermined number of times NRE (step 58). If the answer is NO, the processing proceeds to the step 55, to calculate the soot suppression necessary retard amount IGCR by the Equation (4).

Meanwhile, if the answer in the step 58 is YES and the counter value i reaches the predetermined number of times NRE, the counter value i is reset to 0 (step 59), and end transition control is ended. Hence, the end transition control flag F_TRNSE is set to “0” (step 60), and the processing is ended. In addition, after performing the step 60, the answer in the step 56 turns to NO, and in this case, too, the processing is immediately ended.

With the end transition control described above, as shown in FIG. 12, the soot suppression necessary retard amount IGCR is calculated so as to gradually increase from the initial value IGCINI at the end of soot suppression retard control to value 0, during a predetermined transition period from the end of the soot suppression retard control.

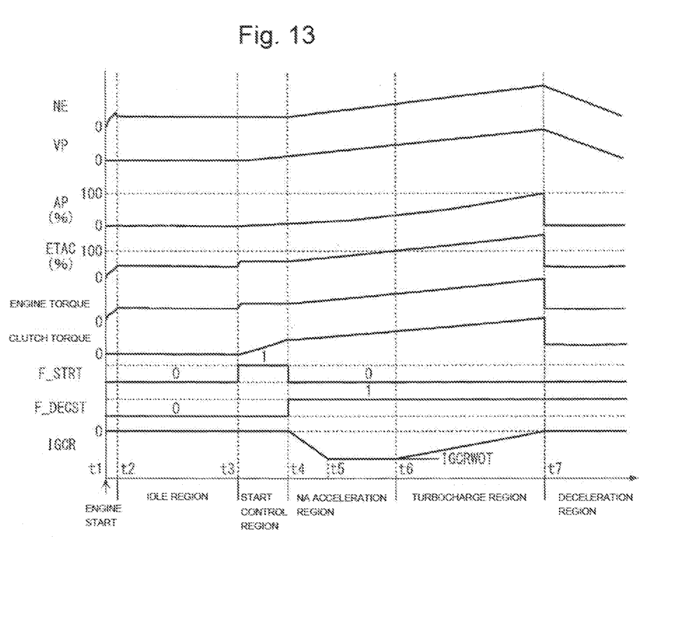

Next, an operation example based on the control processing described above will be described with reference to FIG. 13. In this example, the engine 3 is started at time point t1, and transitions to an idle region at time point t2. In the idle region, the idle flag F_IDL is set to “1,” and since the answer in step 21 of FIG. 4 is YES, soot suppression retard control is prohibited, the soot suppression retard control flag F_DECST is set to “0,” and the soot suppression necessary retard amount IGCR is set to 0 (steps 24, 25).

Thereafter, a clutch (not shown) is connected, and as the accelerator opening AP starts to increase with depression of the accelerator pedal, start control is started (time point t3). In a start control region, the start control flag F_STRT is set to “1,” and since the answer in step 22 is YES, soot suppression retard control is still prohibited.

Thereafter, as the vehicle speed VP increases, for example, start control ends (time point t4), and the engine transitions to an NA acceleration region (acceleration operation where charging efficiency ETAC is not higher than 100%). With this, the start control flag F_STRT is reset to “0,” whereby the soot suppression retard control flag F_DECST is set to “1” (step 27), and soot suppression retard control is started. At the start of soot suppression retard control, the control start transition processing of FIG. 9 causes the soot suppression necessary retard amount IGCR to gradually decrease (time points t4 to t5) from value 0 to the target value in the NA acceleration region.

Thereafter, as the accelerator opening AP increases further, the NA full admission state (charging efficiency ETAC=100%) is formed (time point t6), and with the actuation of the turbo charger 9, the engine transitions to the turbocharge region (charging efficiency ETAC>100%). In the turbocharge region, the soot suppression necessary retard amount IGCR is calculated by the Equation (2) (step 38). As a result, the soot suppression necessary retard amount IGCR gradually increases from the NA full admission-retard amount IGCRWOT toward value 0 according to the charging efficiency ETAC, and when the accelerator opening AP reaches 100% (full admission) and the charging efficiency ETAC becomes the maximum charging efficiency ETACMAX corresponding to the maximum turbocharge pressure POBJ (time point t7), the soot suppression necessary retard amount is set to value 0. In this example, the accelerator opening AP abruptly drops to 0 at this time point t7, and the engine transitions to a deceleration region.

As has been described, according to the embodiment, by performing soot suppression retard control according to the detected operation state of the engine 3, the ignition timing is retarded by the soot suppression necessary retard amount IGCR from the reference ignition timing. Accordingly, since the ignition timing IGLOG is retarded by the soot suppression necessary retard amount IGCR and the combustion temperature is reduced, the soot generation amount in exhaust gas can be suppressed.

Additionally, the optimal ignition timing IGMBT when the maximum output torque of the engine 3 can be obtained is calculated according to the engine speed NE and the suction pressure PBA, and the optimal ignition timing IGMBT is used as a reference to retard the ignition timing by the soot suppression necessary retard amount IGCR. Hence, the soot generation amount can be suppressed while favorably maintaining the traveling performance and fuel economy.

Furthermore, the basic value IGCRBS of the soot suppression necessary retard amount IGCR is calculated by use of the basic value map of FIG. 5, on the basis of the engine speed NE, the charging efficiency ETAC, and the engine water temperature TW. It has been confirmed that these three operation parameters are closely connected with the soot generation amount in exhaust gas. Accordingly, the basic value IGCRBS can be calculated appropriately, and an excellent effect of suppressing the soot generation amount can be achieved.

Additionally, the basic value IGCRBS is set only for the low-water temperature region where the engine water temperature TW is lower than a predetermined temperature. In other words, soot suppression retard control is performed on condition that the engine 3 is in a predetermined low-temperature region. Hence, the effect of suppressing the soot generation amount can be achieved favorably in the low-temperature region, and also retardation of the ignition timing in the high-temperature region where the suppression effect is small is prohibited, so that degradation in traveling performance or fuel economy can be avoided.

Furthermore, prohibition of soot suppression retard control during idle operation, start control, and no-load control enables preferential and stable speed control for maintaining the engine speed NE at a target speed. In load operation states of the engine 3 other than the above states, soot suppression retard control is performed to achieve the effect of suppressing the soot generation amount as much as possible.

Additionally, the engine speed NE and the engine water temperature TW used for calculation of the basic value IGCRBS are generally used for engine control, and the same holds for the suction pressure PBA and the intake amount GAIR used for calculation of the charging efficiency ETAC. Accordingly, existing sensors normally provided to detect these operation parameters can be used to calculate the soot suppression necessary retard amount IGCR. As a result, special devices such as a particulate matter sensor and an exhaust gas temperature sensor in conventional controllers are unnecessary, and the configuration, control processing, and the like of the controller can be simplified.

Additionally, since the above operation state parameters are used, unlike conventional controllers, there is no need to detect particulate matter concentration in exhaust gas discharged from the engine 3. This can further suppress emission of particulate matter.

Furthermore, by assigning the retard limit value IGRTDLMT to the basic value IGCRBS, the soot suppression necessary retard amount IGCR is calculated to be limited more strictly for a lower atmospheric pressure and a lower engine water temperature TW. Hence, reduction of the output torque by a retarded ignition timing can be suppressed. This can ensure an output torque required for starting the vehicle at high altitude or at the time of a cold start, and ensure excellent startability of the vehicle.

Additionally, in the turbocharge region, the soot suppression necessary retard amount IGCR is calculated by use of the Equation (2), so as to be limited more strictly for a larger charging efficiency ETAC, and to be set to value 0 when the charging efficiency ETAC is the maximum charging efficiency ETACMAX corresponding to the maximum turbocharge pressure POBJ (FIG. 8). Hence, an appropriate effect of suppressing the soot generation amount can be achieved while also ensuring an output torque corresponding to the load on the engine 3, not only in the normally aspirated operation state, but also in the turbocharged operation state.

Furthermore, at the start of soot suppression retard control, the control start transition processing of FIG. 9 causes the soot suppression necessary retard amount IGCR to be calculated so as to gradually decrease from value 0 to a target value of the transition destination (FIG. 10), and at the end of soot suppression retard control, the control end transition processing of FIG. 11 causes the soot suppression necessary retard amount to be calculated so as to gradually increase from the initial value IGCRINI at the end of the soot suppression retard control, to value 0 (FIG. 12). With this, an abrupt change in the soot suppression necessary retard amount IGCR at the start and end of soot suppression retard control can be prevented, and elevation changes in the output torque of the engine 3 and excessive acceleration and deceleration can be prevented.

Additionally, the knocking suppression necessary retard amount IGKNOCK is calculated on the basis of the occurrence limit of knocking, and update of the knock learning value IGKCS is prohibited when the soot suppression necessary retard amount IGCR is on the retard side of the knocking suppression necessary retard amount IGKNOCK. Hence, erroneous learning of knocking can be surely avoided.

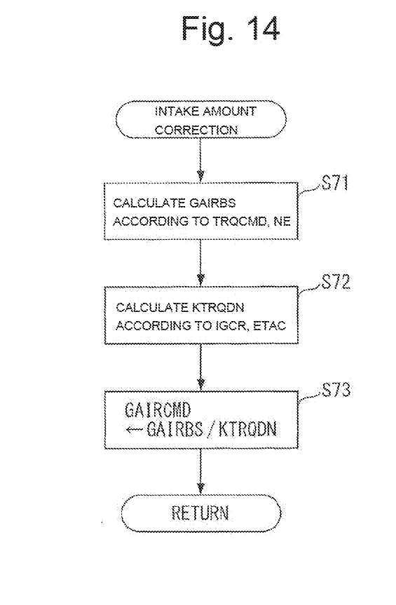

Next, intake amount correction processing will be described with reference to FIG. 14. The processing is performed to compensate for an intake amount corresponding to a reduced amount of output torque of the engine 3 when soot suppression retard control has been performed, and is repeatedly performed in synchronization with generation of a TDC signal.

In the processing, first, in step 71, a basic value GAIRBS of a target intake amount GAIECMD is calculated, by searching a predetermined basic value map (not shown) according to a target torque TRQCMD and the engine speed NE. In the basic value map, the basic value GAIRBS is set to be substantially proportional to the target torque TRQCMD. Note that the target torque TRQCMD is calculated according to the accelerator opening AP and the engine speed NE.

Next, a torque-down rate KTRQDN is calculated (step 72) by searching a predetermined torque-down rate map (not shown) according to the soot suppression necessary retard amount IGCR and the charging efficiency ETAC. The torque-down rate KTRQDN indicates a torque reduction rate based on an output torque (Hereinafter, referred to as “MBT combustion torque”) of the engine 3 obtained during combustion at the optimal ignition timing IGMBT. In the torque-down rate map, the torque-down rate KTRQDN is set to a smaller value for a smaller soot suppression necessary retard amount IGCR (on the retard side) since the output torque is reduced.

Next, a target intake amount GAIRCMD is calculated (step 73) by assigning the basic value GAIRBS and the torque-down rate KTRQDN to the following Equation (5), to end the processing.

GAIRCMD=GAIRBS/KTRQDN (5)

The MBT combustion torque is basically proportional to the intake amount, and the torque-down rate KTRQDN is based on the MBT combustion torque, as mentioned earlier. According to this relationship, by dividing the basic value GAIRBS by the torque-down rate KTRQDN in Expression (5) to increase and correct the target intake amount GAIRCMD, an intake amount corresponding to the reduced amount of output torque when soot suppression retard control has been performed is appropriately compensated for. Hence, reduction of the output torque of the engine 3 can be prevented, and the target torque TRQCMD can be ensured.

Note that the present invention is not limited to the described embodiment, and may be implemented in various forms. For example, in the embodiment, the optimal ignition timing IGMBT is calculated by use of a map (not shown), and the basic value IGCRBS of the soot suppression necessary retard amount IGCR is calculated by use of the map of FIG. 5. However, the two maps may be integrated into a single map by including the input parameters of both maps, and a value obtained by retarding the ignition timing by a retard amount corresponding to the basic value IGCRBS from the optimal ignition timing IGMBT may be set as a map value.

Moreover, in the embodiment, the optimal ignition timing IGMBT is used as a reference ignition timing to be used as a reference of the soot suppression necessary retard amount IGCR. However, a certain reference ignition timing (e.g., a predetermined crank angle near the compression top dead center) may be used instead. Additionally, in the intake amount correction processing of FIG. 14, the torque-down rate KTRQDN based on the MBT combustion torque is used as an intake amount correction parameter for compensating for the reduced amount of output torque resulting from soot suppression retard control. However, other suitable intake amount correction parameters may be used, as a matter of course.

Additionally, while the embodiment is an example where the present invention is applied to a gasoline engine of a vehicle, the invention is not limited to this, and is applicable to engines of other forms or engines for other usages, such as a marine propulsion engine like an outboard engine including a vertically arranged crankshaft. Moreover, the configuration of detailed parts may be modified appropriately within the gist of the invention.

1. A controller of an internal combustion engine, comprising:
operation state detection means for detecting an operation state of an internal combustion engine;
retard amount calculation means for calculating, according to the detected operation state of the internal combustion engine, a particulate matter suppression retard amount which is a retard amount effective to suppress a generation amount of particulate matter in exhaust gas of said internal combustion engine; and
retard control means for performing particulate matter suppression retard control by retarding an ignition timing by said particulate matter suppression retard amount from a predetermined reference ignition timing.

2. The controller of an internal combustion engine according to claim 1, further comprising:
reference ignition timing calculation means for calculating, according to the operation state of said internal combustion engine, an optimal ignition timing as said reference ignition timing at which a maximum output torque of said internal combustion engine is obtained, wherein
said retard control means retards the ignition timing by said particulate matter suppression retard amount from said optimal ignition timing to set the ignition timing of said internal combustion engine.

3. The controller of an internal combustion engine according to claim 1, wherein
said operation state detection means detects a temperature of said internal combustion engine as the operation state of the internal combustion engine, and
said retard control means performs said particulate matter suppression retard control when it is detected that said detected temperature of the internal combustion engine is within a predetermined low-temperature region.

4. The controller of an internal combustion engine according to claim 1, wherein
said internal combustion engine is a power source mounted in a vehicle, and
said retard control means performs said particulate matter suppression retard control, in a load operation state of said internal combustion engine which does not include an idle operation state or a no-load operation state where said vehicle is parked and a shift lever of the vehicle is in a neutral or parking position.

5. The controller of an internal combustion engine according to claim 2, wherein
said operation state detection means detects a speed, a load, and a temperature of the internal combustion engine as the operation state of the internal combustion engine, and
said retard amount calculation means calculates said particulate matter suppression retard amount on the basis of said detected speed, load, and temperature of the internal combustion engine.

6. The controller of an internal combustion engine according to claim 2, wherein
said retard amount calculation means calculates, at a start of said particulate matter suppression retard control, said particulate matter suppression retard amount, such that the particulate matter suppression retard amount gradually varies from a value immediately before the start, toward a retard side.

7. The controller of an internal combustion engine according to claim 2, wherein
said retard amount calculation means calculates, at an end of said particulate matter suppression retard control, said particulate matter suppression retard amount, such that the particulate matter suppression retard amount gradually varies from a value immediately before the end, toward an advance side.

8. The controller of an internal combustion engine according to claim 2, wherein
said operation state detection means detects an atmospheric pressure as the operation state of said internal combustion engine, and
said retard amount calculation means calculates said particulate matter suppression retard amount, such that the particulate matter suppression retard amount is limited more strictly for a lower value of said detected atmospheric pressure.

9. The controller of an internal combustion engine according to claim 2, wherein
said operation state detection means detects a temperature of said internal combustion engine as the operation state of the internal combustion engine, and
said retard amount calculation means calculates said particulate matter suppression retard amount, such that the particulate matter suppression retard amount is limited more strictly for a lower value of said detected temperature of the internal combustion engine.

10. The controller of an internal combustion engine according to claim 1, further comprising:
target intake amount setting means for setting a target intake amount according to a target torque of said internal combustion engine;
intake amount correction parameter calculation means for calculating, according to said particulate matter suppression retard amount, an intake amount correction parameter for compensating for an intake amount corresponding to a reduced amount of output torque of said internal combustion engine when said particulate matter suppression retard control is performed; and
intake amount correction means for increasing said set target intake amount according to the calculated intake amount correction parameter.

11. The controller of an internal combustion engine according to claim 2, further comprising:
knocking suppression retard amount calculation means for calculating a knocking suppression retard amount as an ignition timing retard amount for suppressing knocking of said internal combustion engine, on a basis of an occurrence limit of the knocking;
learning means for updating, on a basis of the knocking suppression retard amount, a knock learning value used for knocking control; and
learning prohibition means for prohibiting the update of said knock learning value when said particulate matter suppression retard amount is on the retard side of said knocking suppression retard amount.

12. The controller of an internal combustion engine according to claim 2, wherein
said internal combustion engine has a turbocharger configured to turbocharge intake air, and
during a turbocharged operation by said turbocharger, said retard amount calculation means calculates said particulate matter suppression retard amount, such that the particulate matter suppression retard amount is limited more strictly for a higher load of said internal combustion engine, and sets said particulate matter suppression retard amount to 0 when a turbocharge pressure is a maximum turbocharge pressure.

13. A controller of an internal combustion engine having a turbocharger configured to turbocharge intake air, the controller comprising:
operation state detection means for detecting an operation state of said internal combustion engine; and
ignition timing retard control means for performing particulate matter suppression retard control by retarding an ignition timing to suppress a generation amount of particulate matter in exhaust gas of said internal combustion engine, according to said detected operation state of the internal combustion engine, in a normally aspirated operation state where operation of said turbocharger is stopped, and in a turbocharged operation state where the operation of said turbocharger is performed.
